(19) United States
(12) Patent Application Publication
(10) Pub. No.: US 2018/0357563 A1
(43) Pub. Date: Dec. 13, 2018

(54) Data Processing System with Machine Learning Engine to Provide Profile Generation and Event Control Functions

(71) Applicant: Bank of America Corporation, Charlotte, NC (US)

(72) Inventors: Manu Kurian, Dallas, TX (US); Paul Roscoe, Treuddyn Flintshire (GB)

(21) Appl. No.: 15/620,926

(22) Filed: Jun. 13, 2017

(51) Int. Cl. G06N 99/00; H04L 29/06

(52) U.S. Cl. CPC G06N 99/005; H04L 63/1425; H04L 63/1416; H04L 63/102

(57) ABSTRACT

Systems for generating profiles based on machine learning data and controlling one or more devices or events are provided. In some examples, a computing platform may generate machine learning datasets based on data from various sources. The machine learning datasets may be used to generate a plurality of profiles, each profile providing a framework to meet particular goals. A user may request implementation of a profile and the computing platform may identify a first profile and associate the first profile with the user. The user may request authorization for an event and the computing platform may evaluate the event to determine whether one or more rules of the plurality of rules associated with the profile have been violated. If not, the computing platform may execute a first control to authorize the event. If so, the computing platform may execute a second control preventing processing of the event (e.g., disabling functionality of one or more devices).

### BACKGROUND

Aspects of the disclosure relate to electrical computers, data processing systems, and machine learning. In particular, one or more aspects of the disclosure relate to implementing and using a data processing system with a machine learning engine to provide profile generation and event control functions.

Educating people and influencing them to implement positive behaviors and behaviors that can positively impact their success can be difficult. Often times, people are unsure of particular behaviors that will positively impact their success. Accordingly, a framework or roadmap for guiding users to implement certain behaviors that are shown to have a positive impact may be advantageous.

### SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

Aspects of the disclosure provide effective, efficient, scalable, and convenient technical solutions that address and overcome the technical problems associated with generating user profiles that may provide a framework for positively impacting a user and controlling one or more events, devices, and the like, in order to aid in users following the framework.

In some examples, a system, computing platform, or the like, may generate one or more machine learning datasets. The one or more machine learning datasets may be generated based on data from various sources, including historical data associated with a plurality of users, event data, location data, and the like. In some examples, the machine learning datasets may link event data or other behavior data to a level of success.

The machine learning datasets may be used to generate a plurality of profiles, each profile providing a framework or roadmap to meet particular goals, implement one or more behaviors, or the like.

In some examples, a user may request implementation of a profile. The system, computing platform, or the like, may identify a first profile and may associate the first profile with the user. Associating the profile with the user may include identifying one or more rules associated with the profile and/or one or more controls associated with the profile.

In some arrangements, the user may request authorization for an event. The request may include data associated with the event. The system, computing platform, or the like, may evaluate the event and associated data to determine whether one or more rules of the plurality of rules associated with the profile have been violated. If not, the system, computing device, or the like, may execute a first control to authorize the event and process the event. If one or more rules have been violated, the system, computing platform, or the like, may execute a second control denying authorization and preventing processing of the event (e.g., disabling functionality of one or more devices).

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIGS. 1A and 1B depict an illustrative computing environment for implementing and using a data processing system with a machine learning engine to provide profile generation and event control functions in accordance with one or more aspects described herein;

FIGS. 2A-2C depict an illustrative event sequence for implementing and using a data processing system with a machine learning engine to provide profile generation and event control functions in accordance with one or more aspects described herein;

FIGS. 3A-3B depict another illustrative event sequence for implementing and using a data processing system with a machine learning engine to provide profile generation and event control functions in accordance with one or more aspects described herein;

FIG. 4 depicts an illustrative method for implementing and using a data processing system with a machine learning engine to perform profile generation and event control functions, according to one or more aspects described herein;

FIG. 5 depicts another illustrative method for implementing and using a data processing system with a machine learning engine to perform profile generation and event control functions, according to one or more aspects described herein;

FIG. 6 depicts yet another illustrative method for implementing and using a data processing system with a machine learning engine to perform profile generation and event control functions, according to one or more aspects described herein;

FIG. 7 illustrates one example user interface for providing profile information according to one or more aspects described herein;

FIG. 8 illustrates one example operating environment in which various aspects of the disclosure may be implemented in accordance with one or more aspects described herein; and

FIG. 9 depicts an illustrative block diagram of workstations and servers that may be used to implement the processes and functions of certain aspects of the present disclosure in accordance with one or more aspects described herein.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

Some aspects of the disclosure relate to using machine learning to generate one or more profiles to provide a framework to encourage behaviors and control devices and events to provide a positive impact.

Often individuals, and particularly young adults, do not implement behaviors that will have a positive impact on their long term goals. In some cases, it may be difficult to understand appropriate behaviors, actions, and the like, to achieve goals, positive impacts, and the like. Accordingly, various behaviors may be implemented that can have a negative impact that may impact the user in the short and long term.

Accordingly, aspects described herein provide for the user of machine learning to generate a plurality of profiles to provide a framework for implementing behaviors that will have a positive impact. Machine learning may be used to process and analyze vast amounts of data from a plurality of users (e.g., hundreds, thousands, or the like). The data may be related to user characteristics (e.g., age, location, income, and the like), as well as events, behaviors and the like. The machine learning datasets may link behaviors to positive outcomes and may generate a plurality of profiles based on the data. The profiles may include allotted percentages, amounts, or the like, that may be used for different categories of events. By following the profile and associated allotments, a user may develop behaviors that may have a positive impact.

In some examples, implementing a profile may include identifying one or more rules associated the profile and one or more controls to execute. In some examples, the controls may be based on the identified rules. The controls may include enabling/disabling functionality of one or more devices or systems, and the like.

These and various other arrangements will be discussed more fully below.

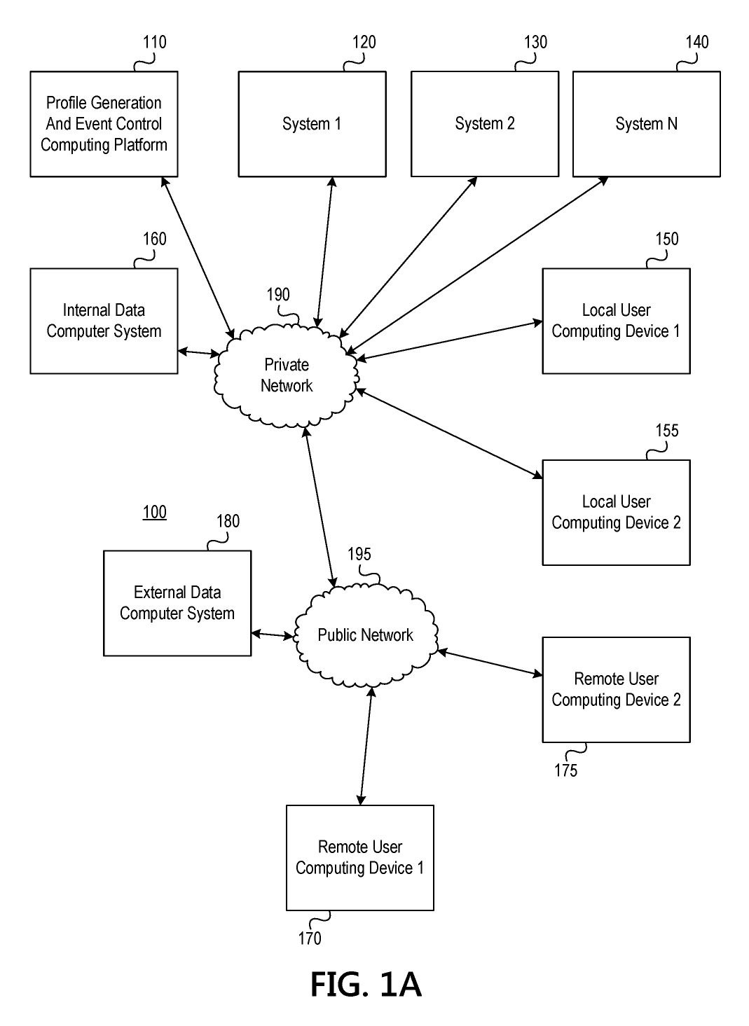

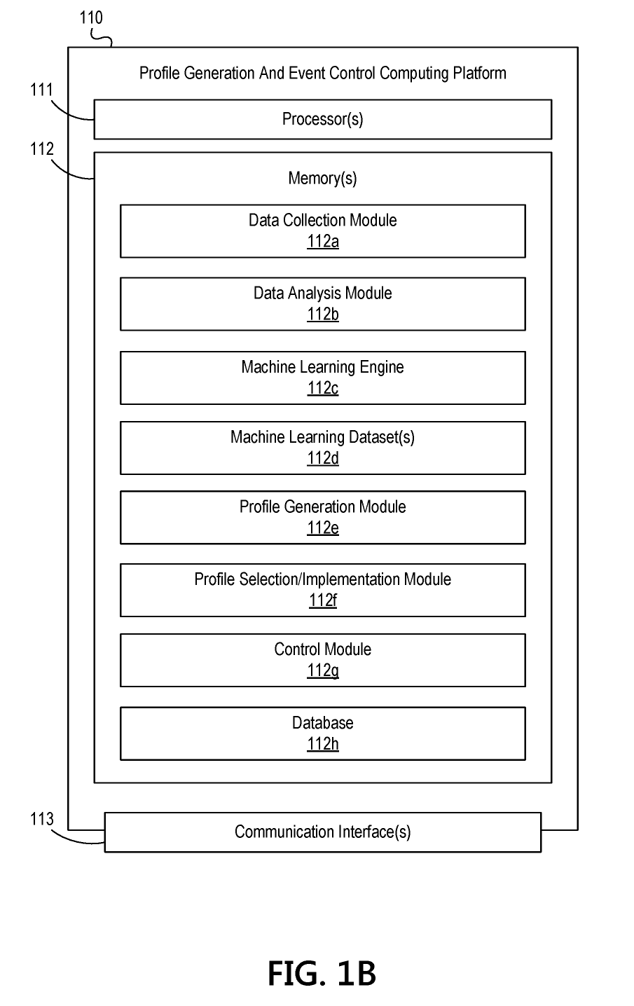

FIGS. 1A and 1B depict an illustrative computing environment for implementing and using a data processing system with a machine learning engine to provide profile generation and event control functions in accordance with one or more aspects described herein. Referring to FIG. 1A, computing environment 100 may include one or more computing devices and/or other computing systems. For example, computing environment 100 may include a profile generation and event control computing platform 110, a first system 120, a second system 130, an Nth system 140, an internal data computer system 160, a first local user computing device 150, a second local user computing device 155, a first remote user computing device 170, a second remote user computing device 175, and an external data computer system 180.

Profile generation and event control computing platform 110 may be configured to host and/or execute a machine learning engine to provide profile generation functions, event control functions, and the like, as discussed in greater detail below. In some instances, profile generation and event control computing platform 110 may receive data from one or more systems, such as systems 120, 130, 140, analyze the data and generate, via a machine learning engine, one or more machine learning datasets. The machine learning datasets may be used to generate one or more profiles for a user, evaluate actions of a user, analyze requested events, and/or control events, devices, and the like, associated with a user.

In some examples, profile generation and event control computing platform 110 may monitor one or more of systems 1 120, system 2 130, and/or system N 140. For instance, profile generation and event control computing platform 110 may receive data streams from the one or more systems, may extract data from the data streams for further analysis and may analyze the extracted data. System 1 120, system 2 130, and/or system N 140, may be any type of system, device, application, or the like, monitored by the profile generation and event control computing platform 110. For instance, the systems may be one or more of servers, applications executing on one or more devices, other computing platforms, and the like. The systems being monitored may, in some examples, be systems and the like, recording events of one or more users, having databases including historical event data associated with one or more users, and the like. In some examples, data may be collected from the one or more systems 120, 130, 140, over a period of time to track behaviors of a user, performance with respect to a predetermined threshold, and the like. This information may be used to generate one or more machine learning datasets.

Internal data computer system 160 may be configured to monitor, collect, store and/or transmit data related to historical user data, account information, and the like. The internal data computer system 160 may include one or more databases configured to store data and transmit data, as requested, to, for instance, the profile generation and event control computing platform 110.

External data computer system 180 may be configured to monitor, collect, store and/or transmit data related to historical external data, such as market performance data, historical transaction data for transactions not involving an entity implementing the system, user behavioral information, social media information for one or more users, and the like. The external data computer system 180 may include one or more databases configured to store data and/or transmit data, as requested, to, for instance, the profile generation and event control computing platform 110.

Local user computing device 150, 155 and remote user computing device 170, 175 may be configured to communicate with and/or connect to one or more computing devices or systems shown in FIG. 1A. For instance, local user computing device 150, 155 may communicate with one or more computing systems or devices via network 190, while remote user computing device 170, 175 may communicate with one or more computing systems or devices via network 195. The local and remote user computing devices may be used to communicate with, for example, profile generation and event control computing platform 110, select a profile, receive and display profile information, status information as compared to a profile, request authorization of an event, receive notifications of event authorization, process one or more events, and the like, as will be discussed more fully below.

In one or more arrangements, system 1 120, system 2 130, system N 140, internal data computer system 160, local user computing device 150, local user computing device 155, remote user computing device 170, remote user computing device 175, and external data computer system 180 may be any type of computing device capable of performing the particular functions described herein. For example, system 1 120, system 2 130, system N 140, internal data computer system 160, local user computing device 150, local user computing device 155, remote user computing device 170, remote user computing device 175, and external data computer system 180 may, in some instances, be and/or include server computers, desktop computers, laptop computers, tablet computers, smart phones, or the like that may include one or more processors, memories, communication interfaces, storage devices, and/or other components. As noted above, and as illustrated in greater detail below, any and/or all of system 1 120, system 2 130, system N 140, internal data computer system 160, local user computing device 150, local user computing device 155, remote user computing device 170, remote user computing device 175, and external data computer system 180 may, in some instances, be special-purpose computing devices configured to perform specific functions.

Computing environment 100 also may include one or more computing platforms. For example, and as noted above, computing environment 100 may include profile generation and event control computing platform 110. As illustrated in greater detail below, profile generation and event control computing platform 110 may include one or more computing devices configured to perform one or more of the functions described herein. For example, profile generation and event control computing platform 110 may include one or more computers (e.g., laptop computers, desktop computers, servers, server blades, or the like).

As mentioned above, computing environment 100 also may include one or more networks, which may interconnect one or more of profile generation and event control computing platform 110, system 1 120, system 2 130, system N 140, internal data computer system 160, local user computing device 150, local user computing device 155, remote user computing device 170, remote user computing device 175, and external data computer system 180. For example, computing environment 100 may include private network 190 and public network 195. Private network 190 and/or public network 195 may include one or more sub-networks (e.g., Local Area Networks (LANs), Wide Area Networks (WANs), or the like). Private network 190 may be associated with a particular organization (e.g., a corporation, financial institution, educational institution, governmental institution, or the like) and may interconnect one or more computing devices associated with the organization. For example, profile generation and event control computing platform 110, system 1 120, system 2 130, system N 140, internal data computer system 160, local user computing device 150, and local user computing device 155 may be associated with an organization (e.g., a financial institution), and private network 190 may be associated with and/or operated by the organization, and may include one or more networks (e.g., LANs, WANs, virtual private networks (VPNs), or the like) that interconnect profile generation and event control computing platform 110, system 1 120, system 2 130, system N 140, internal data computer system 160, local user computing device 150, and local user computing device 155 and one or more other computing devices and/or computer systems that are used by, operated by, and/or otherwise associated with the organization. Public network 195 may connect private network 190 and/or one or more computing devices connected thereto (e.g., profile generation and event control computing platform 110, system 1 120, system 2 130, system N 140, internal data computer system 160, local user computing device 150, and/or local user computing device 155) with one or more networks and/or computing devices that are not associated with the organization. For example, remote user computing device 170, remote user computing device 175, and external data computer system 180 might not be associated with an organization that operates private network 190 (e.g., because remote user computing device 170, remote user computing device 175, and external data computer system 180 may be owned, operated, and/or serviced by one or more entities different from the organization that operates private network 190, such as one or more customers of the organization, public or government entities, and/or vendors of the organization, rather than being owned and/or operated by the organization itself or an employee or affiliate of the organization), and public network 195 may include one or more networks (e.g., the internet) that connect remote user computing device 170, remote user computing device 175, and/or external data computer system 180 to private network 190 and/or one or more computing devices connected thereto (e.g., profile generation and event control computing platform 110, system 1 120, system 2 130, system N 140, internal data computer system 160, local user computing device 150, and/or local user computing device 155).

Referring to FIG. 1B, profile generation and event control computing platform 110 may include one or more processors 111, memory 112, and communication interface 113. A data bus may interconnect processor(s) 111, memory 112, and communication interface 113. Communication interface 113 may be a network interface configured to support communication between profile generation and event control computing platform 110 and one or more networks (e.g., private network 190, public network 195, or the like). Memory 112 may include one or more program modules having instructions that when executed by processor(s) 111 cause profile generation and event control computing platform 110 to perform one or more functions described herein and/or one or more databases that may store and/or otherwise maintain information which may be used by such program modules and/or processor(s) 111. In some instances, the one or more program modules and/or databases may be stored by and/or maintained in different memory units of profile generation and event control computing platform 110 and/or by different computing devices that may form and/or otherwise make up profile generation and event control computing platform 110.

For example, memory 112 may have, store, and/or include a data collection module 112a. Data collection module 112a may store instructions and/or data that may cause or enable the profile generation and event control computing platform 110 to receive and/or store data from one or more systems, such as systems 120, 130, 140, internal data computer system 160, external data computer system 180, and the like. The data collection module 112a may receive, for example, data streams from one or more systems or devices, may monitor (e.g., continuously, in real-time, and the like) one or more systems or devices, and the like, to collect data related to one or more users. In some examples, data may be collected from a plurality of systems and may related to hundreds, thousands or hundreds of thousands of users. Data may include current status data of the user (e.g., a determination of whether is user is financially secure based on, for example, comparison to one or more thresholds), historical event data of the user, historical status data of the user (e.g., to determine whether the user is more or less financially secure currently than in a previous time), behaviors or habits of one or more users, user characteristics, social media data, and the like.

Memory 112 may further have, store and/or include a data analysis module 112b. The data analysis module 112b may store instructions and/or data that may cause or enable the profile generation and event control computing platform 110 to analyze the data received by the data collection module 112a to sort data, extract data, and the like. For instance, data analysis module 112b may group data according to user characteristics (e.g., age, employment status, location, social media information, and the like). Additionally or alternatively, the analysis of the data may include grouping data according to whether an event or other activity or occurrence had a positive or negative effect on the user. For instance, data for one or more users may be collected over a period of time to determine whether user behaviors, events, activities, and the like, were successful (e.g., had a positive impact on the user) or were unsuccessful (e.g., had a negative impact on the user). In some examples, success may include different levels (e.g., data may be characterized as highly successful, successful, moderately successful, and unsuccessful, in one example).

The profile generation and event control computing platform 110 may further have, store, and/or include a machine learning engine 112c and machine learning datasets 112d. Machine learning engine 112c and machine learning datasets 112d may store instructions and/or data that cause or enable profile generation and event control computing platform 110 to generate one or more profiles based on the analyzed data from data analysis module 112b, determine whether a user is following a selected profile, control devices and/or events associated with a user, and the like. The machine learning datasets 112d may be generated based on analyzed data (e.g., from the data analysis module 112b), raw data (e.g., from data collection module 112a), and/or received from one or more outside sources.

The machine learning engine 112c may receive data (e.g., data collected from a plurality of sources) and, using one or more machine learning algorithms, may generate one or more machine learning datasets 112d. Various machine learning algorithms may be used without departing from the invention, such as supervised learning algorithms, unsupervised learning algorithms, regression algorithms (e.g., linear regression, logistic regression, and the like), instance based algorithms (e.g., learning vector quantization, locally weighted learning, and the like), regularization algorithms (e.g., ridge regression, least-angle regression, and the like), decision tree algorithms, Bayesian algorithms, clustering algorithms, artificial neural network algorithms, and the like. Additional or alternative machine learning algorithms may be used without departing from the invention. In some examples, the machine learning engine 112c may analyze data to identify patterns of activity, sequences of activity, and the like, to generate one or more machine learning datasets 112d.

The machine learning datasets 112d may include machine learning data linking one or more user activities or behaviors to a level of success. Accordingly, the machine learning datasets 112d may be used to generate one or more user profiles, including one or more rules, that can be selected by or assigned to a user in order to provide a roadmap or framework for future behaviors. For instance, data from a plurality of users over a predetermined period of time (e.g., one month, one year, five years, 10 years, or the like) may be received and analyzed to identify behaviors, events, activities, or the like, that have a positive impact on a user. For instance, the system may evaluate spending, saving, and/or other financial behaviors to identify users that are in a better financial position at the end of the predetermined time period than at the beginning (e.g., have more money in savings, have less debt, have more assets, or the like). Machine learning datasets may be generated that link one or more events, activities, behaviors, or the like, to one or more levels of success or one or more positive outcomes.

The machine learning datasets 112d may be updated and/or validated based on the data received from one or more systems 120, 130, 140, and/or internal data computer system 160, external data computer system 180, and the like. For instance, as additional data is received, the machine learning datasets 112d may be validated and/or updated based on the newly received information. Accordingly, the system may continuously refine recommendations, profiles, profile rules, and the like.

The machine learning datasets 112d may be used by, for example, profile generation module 112e to generate one or more user profiles. For instance, profile generation module 112e may store data and/or instructions that may cause or enable the profile generation and event control computing platform 110 to generate one or more profiles that may be applied to a user to provide a framework for behaviors that may control activities and/or have a positive impact on a user.

For instance, one or more profiles may be generated for a user in a particular age range (e.g., college age) and may include allotted amounts to spend on, for instance, food, beverage, rent, utilities, and the like, while identifying an allotted amount to save for future use. In some examples, the allotted amounts may be a percentage of income of the user. In another example, a profile may be generated for a teenager allotting certain amounts or percentages to leisure activities, food and beverage, and the like and identifying an amount to save for future use. These profiles may be configured to provide a framework for spending and saving to build strong spending and saving habits, avoid incurring debt, and the like.

Various other example profiles may be generated, as will be discussed more fully herein. These and other profiles may be used without departing from the invention.

The profile generation and event control computing platform 110 may further have, store and/or include a profile selection/implementation module 112f. The profile selection/implementation module 112f may have instructions and/or data that may cause or enable profile generation and event control computing platform 110 to identify a profile for a user and implement the identified profile. For instance, a user may register with the profile generation and event control computing platform 110 (e.g., via one or more of local user computing device 150, 155, remote user computing device 170, 175, or the like). The registration process may include providing information about the user, e.g., age, location, employment status, income, and the like. This information may be used to select a profile from a plurality of profiles generated (e.g., based on one or more machine learning datasets). In some examples, the profile may be automatically selected by the profile generation and event control computing platform 110. In other examples, a profile may be selected by a user, person associated with a user, such as a parent or guardian, or the like.

The profile selection/implementation module 112f may further include instructions and/or data that may cause or enable profile generation and event control computing platform 110 to implement a selected profile. For instance, implementing a selected or identified profile may include identifying one or more accounts of a user, identifying a mobile device associated with the user, transmitting one or more notifications to the user that the profile has been implemented, and the like. In some examples, implementing a profile may include causing the profile generation and event control computing platform 110 to transmit an application (e.g., download the application) to a user device (e.g., local user computing device 150, 155, remote user computing device 170, 175). In some examples, transmitting the application may include causing the application to execute on the device. In some example, the application may run in a background on the device, such as on a mobile device. In other examples, an application may be downloaded to a user device upon registering with the profile generation and event control computing platform 110, upon request, or the like.

Implementing the identified/selected profile may include identifying one or more rules associated with the profile. For instance, the profile may include one or more spending rules for one or more types of purchases, one or more saving rules, and the like. Accordingly, upon attempting to process an event, the profile generation and event control computing platform 110 may compare the requested event to one or more rules of the profile to determine whether a rule is violated. One or more controls may be executed based on whether a rule is violated.

The profile generation and event control computing platform 110 may further include control module 112g. Control module 112g may have or store instructions and/or data that may cause or enable the profile generation and event control computing platform 110 to control one or more aspects of a user account, device, or the like. For instance, the profile generation and event control computing platform 110 may review any purchases or other events attempted by a user to confirm whether one or more rules are violated and, if not, processing the event. If so, the computing platform 110 may prevent processing of the event (e.g., temporarily disable a credit or debit card, temporarily disable a payment application, or the like). The control module 112g may generate and/or transmit instructions, commands, signals, or the like, to a user device to process or prevent processing of an event (e.g., execute a control command), based on whether the event meets one or more requirements or rules of a profile.

The profile generation and event control computing platform 110 may further include a database 112h. Database 112h may store user information, profile information, historical data, and the like.

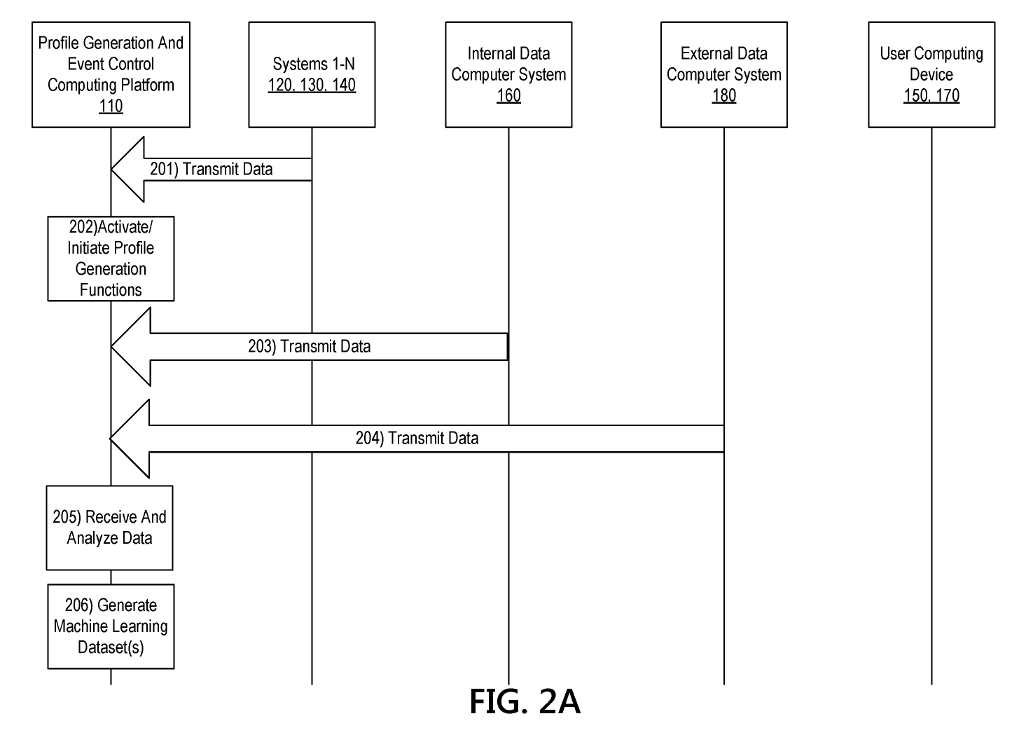

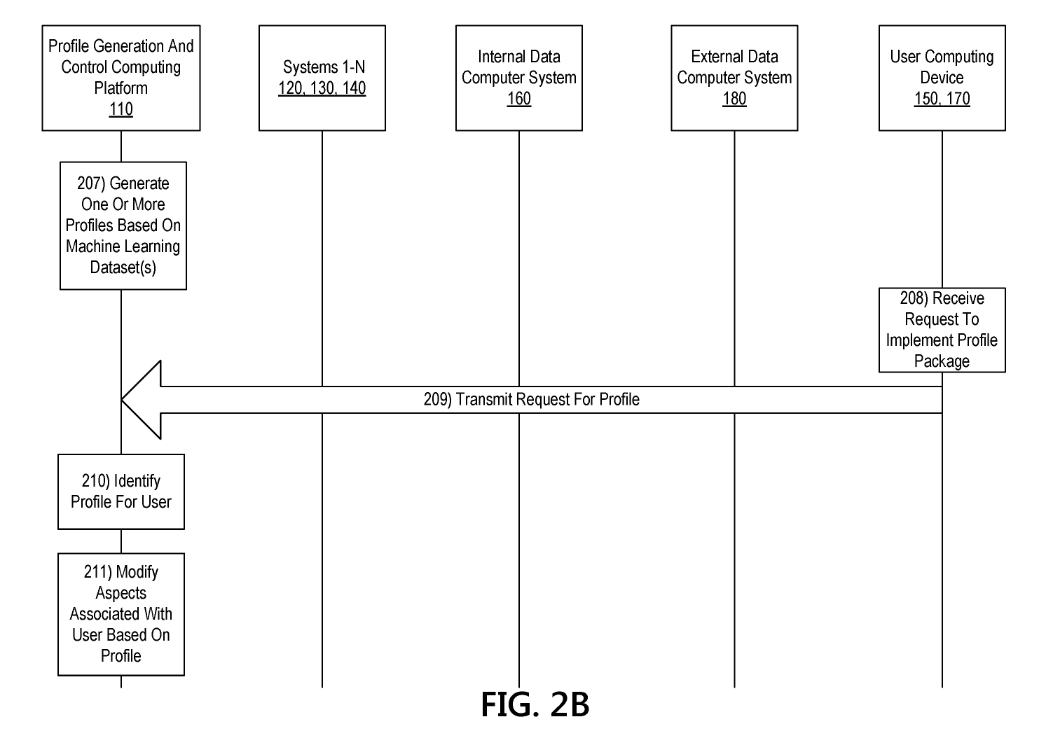

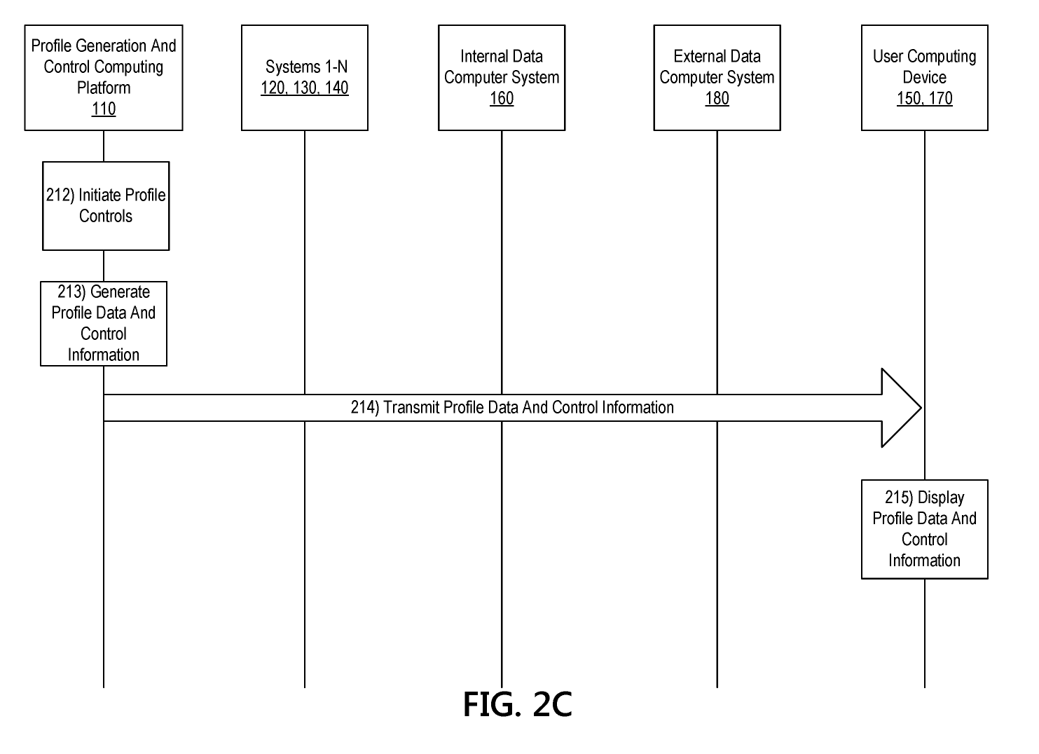

FIGS. 2A-2C depict an illustrative event sequence for implementing and using a data processing system with a machine learning engine to provide profile generation and event control functions in accordance with one or more aspects described herein. The events shown in the illustrative event sequence are merely one example sequence and additional events may be added, or events may be omitted, without departing from the invention.

Referring to FIG. 2A, at step 201, content data may be transmitted from one or more systems, such as system 1 120, system 2 130, system N 140 and received by, for instance, the profile generation and event control computing platform 110. As discussed above, systems 120, 130, 140 may be any type of system, device, application, or the like. The content data may include data associated with one or more users (e.g., identifying information, characteristic information such as age, income, location, or the like, account information, or the like), data associated with one or more events of one or more users (e.g., historical transaction data including, for instance, amount of transaction, location, type of transaction, or the like). Various other types of data may be received without departing from the invention.

In step 202, in response to receiving data from one or more systems, one or more profile generation functions may be activated or initiated. For instance, responsive to receiving data from one or more systems, the profile generation and event control computing platform 110 may initiate one or more functions to generate one or more profiles, select one or more profiles for implementation, execute controls, and the like.

In step 203, data may be received from other data sources, such as internal data computer system 160. The data may be related to events of one or more users, accounts of one or more users, and the like. In step 204, data may be received from, for instance, external data computer system 180. This data may include data associated with market performance of one or more markets or indices, general economic climate information, and the like.

In step 205, the profile generation and event control computing platform 110 may analyze the received data. Analyzing the received data may include grouping events according to one or more applicable categories, such as type of event, amount of event, location, or the like. Analyzing the data may further include tracking particular users over a period of time to determine whether they were in a better position at an end of a time period than at a start (e.g., had more money saved, had less debt, or the like). Events and/or other habits or behaviors of the users may also be evaluated. In some examples, analyzing the data may include identifying one or more behaviors and rating a level of success associated with the behavior. In some examples, the behaviors may then be grouped according to, for instance, level of success.

In step 206, one or more machine learning datasets may be generated based on the analyzed data. For instance, one or more machine learning datasets may be generated based on the analyzed data including, for instance, behaviors identified as successful, user characteristics, event data, and the like. The one or more machine learning datasets may link one or more behaviors, type of events, or the like, to one or more levels of success.

With reference to FIG. 2B, in step 207, one or more profiles may be generated based on the one or more machine learning datasets. For instance, machine learning datasets linking behaviors to one or more levels of success, as well as user characteristic data, may be used to generate one or more profiles. In some examples, the profiles may provide a roadmap or framework for controlling user behaviors in an effort to provide a successful outcome for the user. In some examples, different profiles may be generated for users of different ages, different income levels, and the like. Each profile may then include a plurality of use rules generated from the machine learning datasets. For instance, each profile may include designated spending limits for certain categories of items, such as food and drink, rent, utilities, entertainment, and the like. The profiles may further include one or more controls that may be executed upon receiving a request to authorize an event (e.g., authorize a purchase or other transaction). For instance, if the requested event violates one or more rules, the system may prevent further processing of the event. Alternatively, if it does not violate one or more rules, or is within predetermined limits, the event may be processed, as will be discussed more fully herein.

In step 208, a request to implement a profile may be received from a user computing device, such as local user computing device 150, remote user computing device 170, or the like. In some examples, the request may be received from a mobile device of a user and may be received via an application downloaded to the mobile device and executing on the mobile device. In some examples, the request may include information associated with the user for which the profile is requested (e.g., name, age, income, location, mobile or other computing device identifier, or the like). In some examples, the request to implement a profile may be received from a first computing device associated with a first user but the profile may be requested for a second user associated with a second, different computing device. For instance, a parent may request a profile implementation for one or more children.

In step 209, the request for profile may be transmitted to the profile generation and event control computing platform 110. In step 210, a profile may be identified or selected for the user. In some examples, the profile may be selected based on user characteristics, such as age, income, location, and the like. In some examples, a user may select one or more goals to achieve via implementation of the profile (e.g., reduce debt, save funds, or the like). The goals may then also be used by the system to select an appropriate profile for implementation.

In step 211, the profile may be implemented and associated with the designated user. In some examples, this may include modifying one or more aspects associated with the designated user. For instance, one or more limits may be placed on accounts of the user, controls may be assigned to the user and/or one or more accounts of the user, or the like.

With reference to FIG. 2C, in step 212, profile controls may be initiated for the user. For instance, one or more controls may be executed to limit or control spending, track events conducted by the user, authorize or prevent processing of events, and the like.

In step 213, profile data and control information may be generated. The profile data and control information may include an outline of the profile and designated limits, as well as identification of the controls to be executed (e.g., authorizing events, preventing processing of an event, or the like). This information may be transmitted to the user computing device 150, 170 in step 214 and, in step 215, may be displayed on the device (e.g., via a user interface).

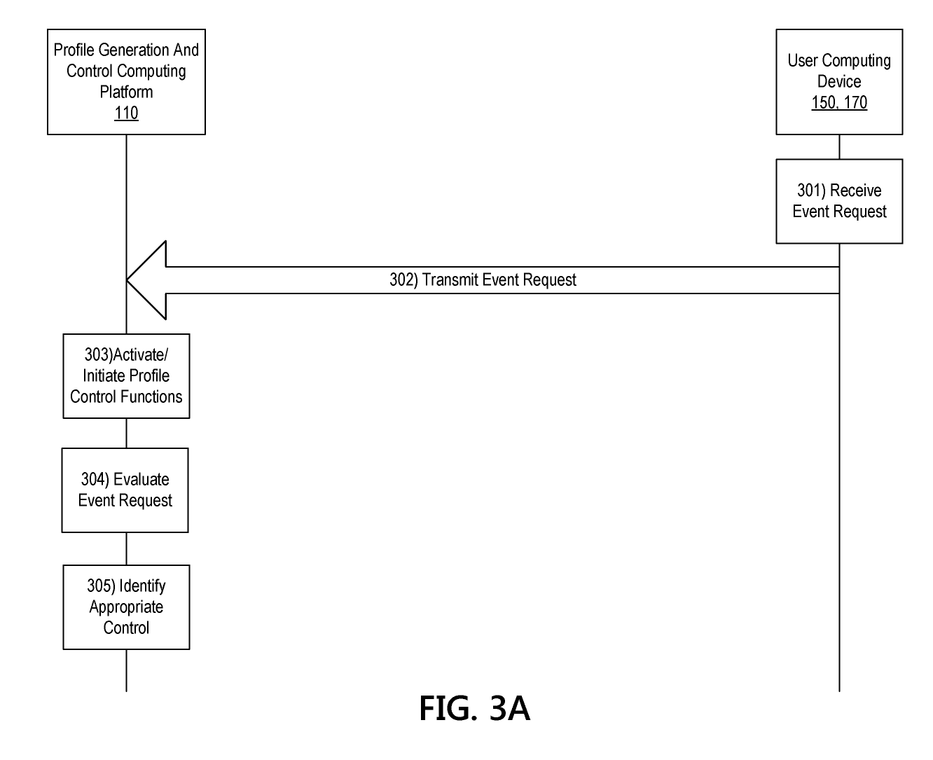

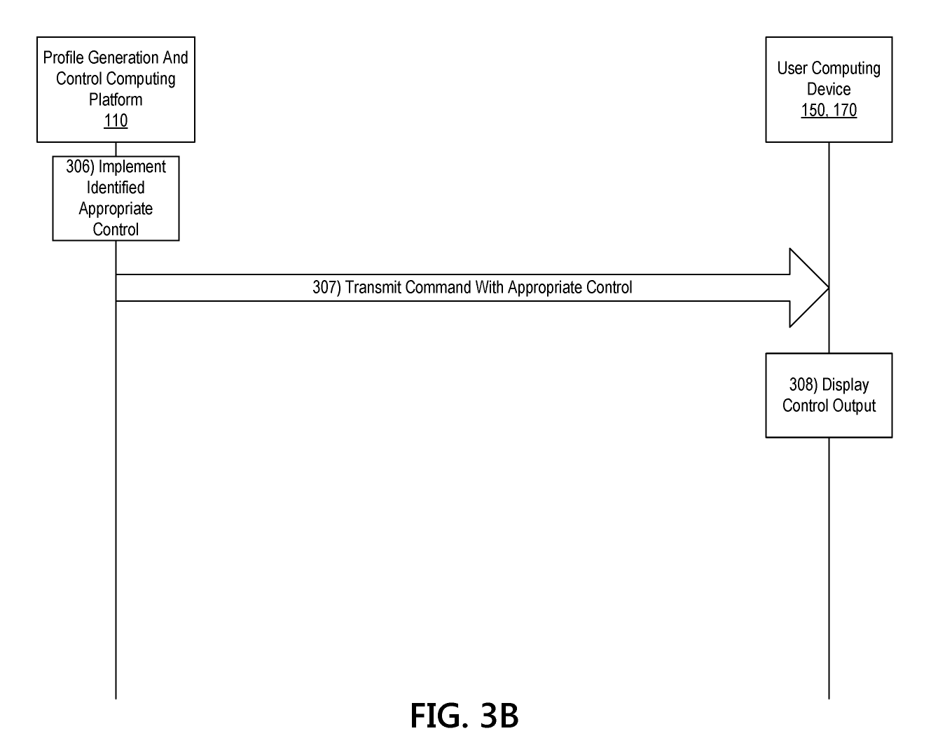

FIGS. 3A and 3B illustrate one example event sequence for implementing and using a data processing system with a machine learning engine to provide profile generation and event control functions in accordance with one or more aspects described herein. Aspects described with respect to FIGS. 3A and 3B, in particular, relate to authorizing events for users having a selected profile that has been implemented. The events shown in the illustrative event sequence are merely one example sequence and additional events may be added, or events may be omitted, without departing from the invention.

Referring to FIG. 3A, at step 301, an authorization request for an event may be received, such as by a user computing device 150, 170. The authorization may be requested via an application executing on the computing device 150, 170, or the like. Some example events for which authorization may be requested may include, but are not limited to, purchase of clothing, purchase of food and beverage, a requested amount for an auto loan or mortgage, or the like. The authorization request may include information related to the type of event, amount associated with the event, and the like.

In step 302, the event authorization request may be transmitted from the user computing device 150, 170 to the profile generation and event control computing platform 110. In step 303, responsive to receiving the event authorization request, one or more profile control functions may be activated or initiated.

In step 304, the received event authorization request may be evaluated. For instance, characteristics of the event authorization request may be compared to one or more predefined rules associated with the profile associated with the user. If one or more rules are violated (or, alternatively, one or more rules are met) the event authorization request may be declined and processing of the event may be prevented. Alternatively, if one or more rules are not violated (or, alternatively, if one or more rules are not met) the event authorization request may be authorized and the event may be processed (e.g., payment completed, or the like).

In step 305, one or more appropriate controls may be determined based on the analysis performed in step 304. For instance, if the event should be authorized, the system may identify controls to process payment associated with the event, enable one or more processing devices (e.g., mobile device payment system, debit card, credit card, or the like), or the like. Alternatively, if the event is not authorized, the system may identify controls to prevent payment associated with the event, disable one or more payment devices (e.g., in situations in which the payment device is enabled for use in a default state or condition), or the like.

With reference to FIG. 3B, in step 306, the identified one or more controls may be implemented and/or executed. For instance, the profile generation and event control computing platform 110 may execute one or more controls to process the event, prevent processing the event, or the like. In some examples, the profile generation and event control computing platform 110 may transmit a command, instruction, signal, or the like, to the mobile device or other computing device of the user to execute the identified control in step 307. In step 308, the control may be executed and a control output may be displayed on a display of the user computing device 150, 170. For instance, the user computing device may display an indication of whether the event was authorized.

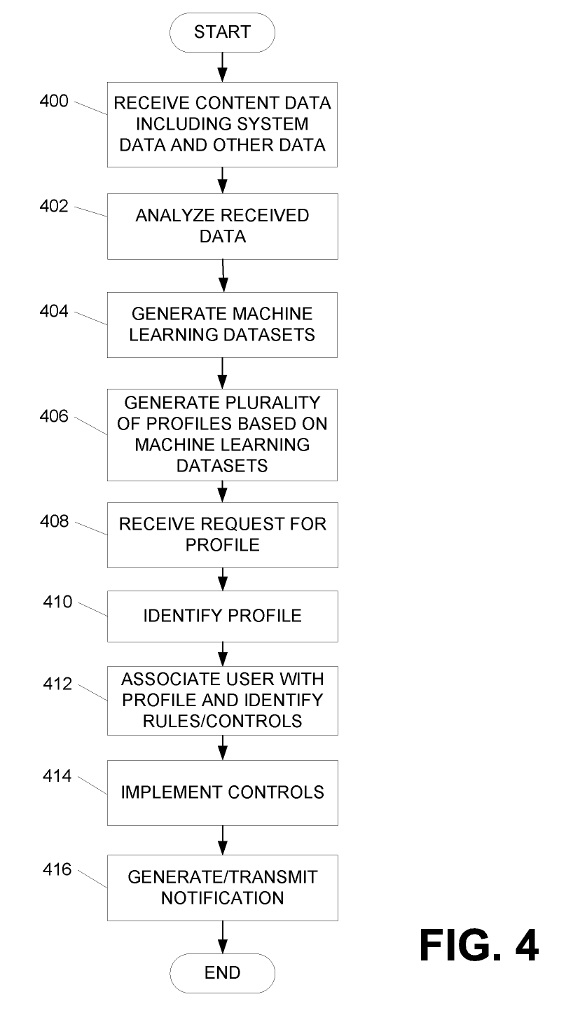

FIG. 4 is a flow chart illustrating one example method of generating profiles and implementing event controls in accordance with one or more aspects described herein. The processes illustrated in FIG. 4 are merely some example processes and functions. The steps shown may be performed in a different order, more steps may be added, or one or more steps may be omitted without departing from the invention.

In step 400, data may be received from one or more systems. For instance, data may be received from systems 120, 130, 140, internal data computer system 160, external data computer system 180, and the like. The data may include data related to a plurality of users, events processed, characteristics of users, and the like.

In step 402, the received data may be analyzed to identify behaviors of users, events associated with users, outcome of events or behaviors, and the like. In step 404, one or more machine learning datasets may be generated based on the analyzed data.

In step 406, a plurality of profiles may be generated based on the machine learning datasets. The profiles may include a roadmap or framework for events, spending habits, and the like. For instance, each profile may include a percentage of income that may be spent on different categories, such as rent, utilities, food and beverage, entertainment, transportation, and the like. The profiles may provide different frameworks for different types of users, users with different goals, users in different age groups, and the like.

In step 408, a request for a user profile may be received. The request may include information associated with the user (e.g., age, income, goals, and the like). In some examples, the request may include information identifying a mobile device of the user (e.g., phone number associated with the device, international mobile equipment identity (IMEI) number, or the like). In some examples, the request may be received via an application downloaded to the mobile device and executing on the mobile device.

In step 410, a profile for the user may be selected or identified. For instance, a profile may be identified for a user based on characteristics of the user, goals of the user, or the like. The identified profile may include a plurality of rules associated with the profile. In step 412, the user may be associated with the identified profile. For instance, associating the user with the identified profile may include identifying or implementing the plurality of rules associated with the profile, identifying controls for execution based on the rules, and the like. In step 414, one or more controls may be identified and/or implemented (e.g., modifying a user account or device to set a maximum amount per event, setting a default state for a payment device to disabled, transmitting an instruction to a mobile payment application to request authorization prior to payment, or the like). In step 416, a notification may be generated and transmitted to the user computing device (e.g., mobile device) indicating that the profile has been selected, outlining the profile, identifying controls implemented, and the like.

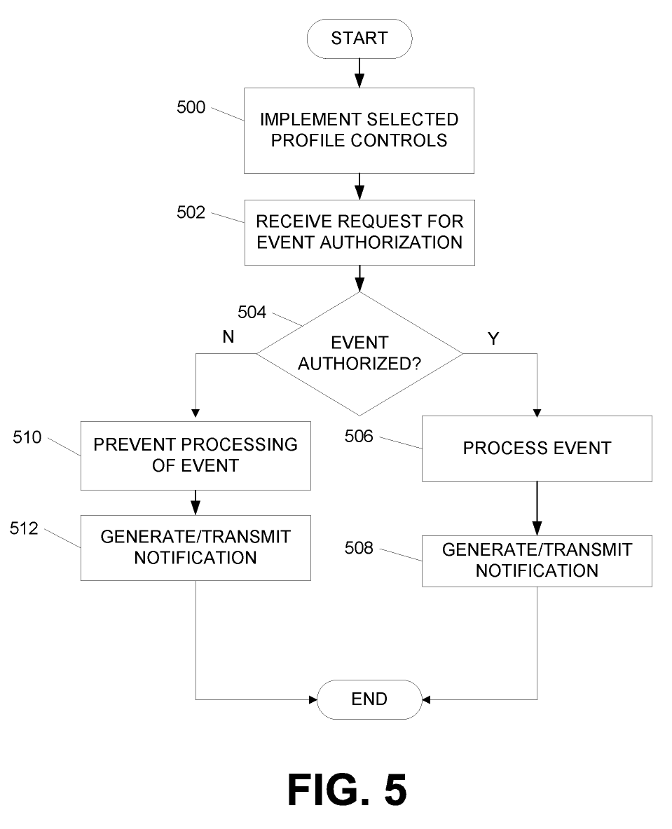

FIG. 5 a flow chart illustrating one example method of implementing event controls in accordance with one or more aspects described herein. The processes illustrated in FIG. 5 are merely some example processes and functions. The steps shown may be performed in a different order, more steps may be added, or one or more steps may be omitted without departing from the invention.

In step 500, a selected profile and one or more associated controls may be implemented, as discussed above. In step 502, a request for an event authorization may be received. As discussed herein, the event may be a purchase, new loan, adjustment to an account, or the like. In step 504, the event authorization request may be evaluated to determine whether the event should be authorized. For instance, data, such as type of event, amount of event, and the like, may be extracted from the event request. This data may be compared to one or more rules associated with the profile, as well as other profile activity, such as other events processed during a predetermined time period (e.g., one week, one month, one year, or the like). For instance, if a user is requesting to purchase a new car and the loan payment will be $150 per month, the system may evaluate the request to determine whether the loan amount violates any rules associated with the profile (e.g., no loans having payments greater than $100 per month, transportation costs may not exceed X % of income, or the like). If the requested event violates any rules associated with the profile, the event authorization request may be denied.

Although the above example describes comparing the data to rules to determine whether one or more rules are violated, various aspects may compare data to rules to determine whether one or more rules are met (e.g., transportation costs below X % of income, loans less than $100 per month) without departing from the invention.

If, in step 504, the event is authorized (e.g., rules associated with the profile are not violated), the event may be processed in step 506. Processing the event may include completing payment associated with the event, enabling a mobile payment system executing on a mobile device of the user to complete processing, enabling functionality associated with a payment device, or the like. In step 508, a notification indicating that the event has been authorized may be generated and transmitted to the user computing device in step 508.

If, in step 504, the event is not authorized, processing of the event may be prevented in step 510. For instance, a command or instruction may be transmitted to a mobile payment system executing on a mobile device of the user disabling payment functionality for this event. In another example, functionality of a payment device may be disabled (e.g., account or payment device may be temporarily disabled, or the like). In step 512, a notification indicating that the requested event was not authorized may be generated and transmitted to the user computing device.

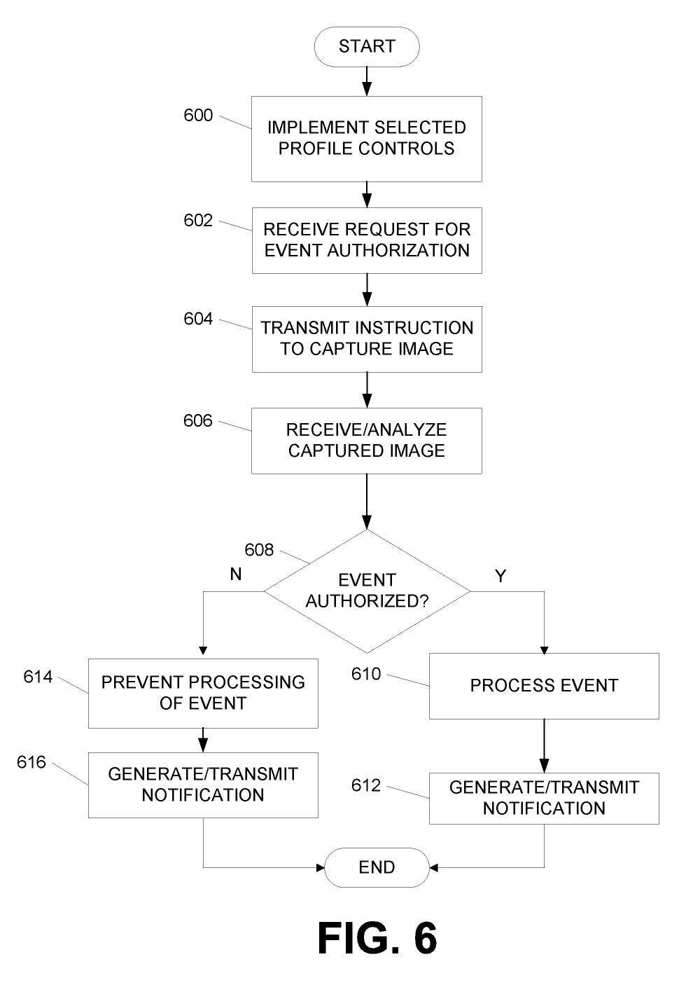

FIG. 6 is a flow chart illustrating one example method of implementing event controls in accordance with one or more aspects described herein. The processes illustrated in FIG. 6 are merely some example processes and functions. The steps shown may be performed in a different order, more steps may be added, or one or more steps may be omitted without departing from the invention.

In step 600, a selected profile and one or more associated controls may be implemented, as discussed above. In some examples, the selected profile may require proof of cost associated with event requests. Such proof may include an image of a price tag associated with the event. In step 602, a request for an event authorization may be received. As discussed herein, the event may be a purchase, new loan, adjustment to an account, or the like.

In step 604, a request to capture an image of a price of the item associated with the event may be transmitted to the mobile computing device of the user. For instance, in some examples, a profile may include a control for payment devices, systems, and the like, to default to a disabled mode. Accordingly, purchases cannot be made without authorization by the profile generation and event control computing platform 110 and enabling the payment device or system by the profile generation and event control computing platform 110. In the profile implemented in FIG. 6, purchases must include proof of price in order to authorize the event and enable payment devices or systems.

In step 606, the captured image may be received and analyzed. The system may determine whether a price of the item associated with the event, and other aspects of the event, violate one or more rules of the profile. In step 608, this information may be used to determine whether the event is authorized. If so, the event may be processed in step 610 and a notification may be generated and transmitted to the user in step 612.

If, in step 608, the event is not authorized, processing of the event may be prevented (e.g., payment devices or systems might not be enabled (or may be disabled if in a default enabled state)) in step 614. In step 616, a notification may be generated and transmitted to the user computing device in step 616.

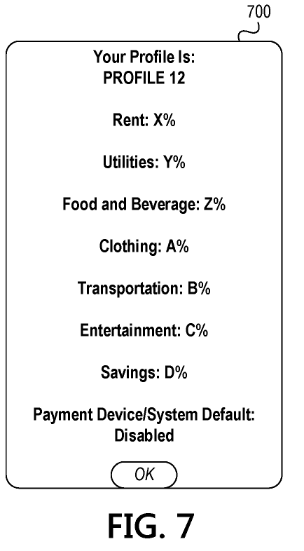

FIG. 7 illustrates one example user interface providing profile and control information to a user. The user interface 700 includes identification of a profile selected or identified for the user and implemented. The interface further includes identification of a percentage of the user's income that may be used for different categories, such as rent, utilities, food and beverage, and the like. More or fewer categories may be provided without departing from the invention.

In some examples, the user interface 700 may further include an indication of one or more controls implemented in association with the profile. For instance, interface 700 includes an indication that payment devices and/or systems associated with the user are now in a default disabled state. Accordingly, the user will not be able to use any payment devices (e.g., debit card, credit card, or the like) or any mobile payment systems executing on the mobile device of the user, without obtaining system authorization first. The profile generation and event control computing platform 110 may then enable payment devices and/or systems upon authorizing a requested event.

In some examples, the system may include an emergency override feature, which would enable payment devices or systems in an emergency situation (e.g., to make payment for healthcare, emergency auto repair, and the like). In these situations, the user may indicate that the event is an emergency situation and the event may be authorized regardless of whether one or more profile rules are violated. In some examples, to avoid overuse of this feature, the user may only execute this feature a predetermined number of times in a given time period (e.g., once per month, twice per month, or the like).

As discussed herein, use of machine learning algorithms to process vast amounts of data, identify successful behaviors, link successful behaviors, and the like, provides an efficient, scalable, continuous process for generating a plurality of user profiles providing a framework or roadmap for user behaviors. In some examples, the data analyzed to generate the machine learning datasets may include historical transaction data from a plurality of users. The system may then evaluate a financial situation of the plurality of users over time (e.g., income level, debt level, savings, or the like) to determine whether the transactions or other events left the user in a better financial position over time or a worse financial position over time. In some examples, the data, behaviors, and the like, may be linked to different levels of success (e.g., highly successful—reduced debt by a first predetermined amount or percentage, increased savings by a first predetermined amount or percentage, or the like; moderately successful—reduced debt by a second predetermined amount or percentage different from the first predetermined amount or percentage, increased savings by a second predetermined amount or percentage, and the like).

As discussed herein, the machine learning datasets may be used to generate one or more profiles. Each profile may include an amount, percentage or the like, of income that may be spent on different categories of spending in a predetermined time period (e.g., one month, one year, or the like). In addition, each profile may include a plurality of rules associated with the profile. Accordingly, a user may have a framework to understand how much money he or she can spend on different items or types of items, such as rent, food and beverage, entertainment, and the like. This may encourage users to develop responsible spending and saving habits and behaviors.

In some examples, the profiles may each include a plurality of rules. The plurality of rules may dictate percentages or amounts spent on different categories, controls to implement on one or more payment devices, mobile payment systems, accounts, or the like. In some examples, users may request authorization to process an event, such as make a purchase, obtain a new loan, or the like. The event may be evaluated by the system to determine whether it violates one or more rules. If so, the system may prevent processing of the event (e.g., may disable functionality of a payment device, such as a debit or credit card, a mobile payment system, or the like).

For instance, data, such as type of event, amount of event, and the like, may be extracted from the event request. This data may be compared to one or more rules associated with the profile, as well as other profile activity, such as other events processed during a predetermined time period (e.g., one week, one month, one year, or the like). For instance, if a user is requesting to purchase dinner for $50, the system may evaluate the request to determine whether the amount violates any rules associated with the profile (e.g., food or beverage purchases greater than $30, no food or beverage purchase greater than X % of weekly or monthly allotment, or the like). If the requested event violates any rules associated with the profile, the event authorization request may be denied. Various other example rules, such as purchases exceeded an amount limit, purchases exceeding a percentage allotted for a category, and the like, may be implemented without departing from the invention.

Accordingly, the system may aid in preventing users from overspending, while encouraging saving and developing responsible financial habits. The arrangements described herein may be implemented for users of varying ages, from teenagers to young adults, to adults to the elderly who may be moving into retirement and need a framework to modify spending and/or saving in view of reduced income. In some examples, a parent or guardian may implement a profile for a child to aid in controlling the child's spending, encourage saving, avoid incurring debt, and the like.

In some examples, the profile may be implemented via an application executing on, for instance, a mobile device of a user. Accordingly, the user may capture images of items being purchased (e.g., new clothing, food or beverage menus, or the like) as well the price associated with the purchase. The system may analyze the image to extract data, such as price data, location data (e.g., from metadata associated with the image) to determine whether to authorize the event (e.g., purchase of the item). If not, the system may disable functionality of one or more payment systems to avoid the user making the purchase.

In some examples, the profiles may be established for users of different ages, incomes, and the like. In addition, profiles may be selected based on one or more goals of a user (e.g., reduce debt, avoid incurring debt, increase savings, and the like). Additionally or alternatively, a profile may be modified or customized by a user. For instance, one or more aspects (e.g., percentage, amount, or the like) may be modified by a user to better fit the user's goals. In some examples, different types of events may have different criteria for authorization.

In some arrangements, a profile may be implemented by a user in a less than full capacity. For instance, the user may select to implement a profile at 80%, 50%, 25%, or the like. In these arrangements, the system may modify percentages, and the like, to reflect that the user desires to have only a portion of their spending, saving, and the like, controlled by the profile.

The arrangements describes herein provide a spending, saving, and the like, framework that may be tailored to an individual user, user's goals, and the like. The profiles implemented herein may control devices, accounts, and the like associated with a user to limit events, transactions, and the like. For instance, functionality of one or more payment devices may be enabled/disabled, functionality of a mobile or online payment system may be enabled/disabled, limits may be placed on withdrawal amounts, and the like.

In some examples, social media sites associated with the user may also be evaluated to generate and transmit notifications to a user. For instance, if a user is detected, via global positioning system information from the mobile device of the user, to be at a mall, and the user has already spent his clothing allowance for a month, a notification may be generated and transmitted to the user indicated that the limit has been reached and no further clothing purchases will be authorized.

In some arrangements, funds not spent by a user in a particular category may be allocated to different areas based on the profile, user preferences, and the like. For instance, if a user does not spend a monthly allotment of funds on entertainment, the remaining funds may be transferred to a savings account, may be rolled over to a subsequent month, or the like, based on one or more rules associated with the profile and/or one or more user preferences.

The profile implementation system may also be used to verify non-financial aspects associated with a user's habits and behaviors. For instance, by authorizing food and beverage purchases, the system may evaluate the types, quantities and the like, of food and beverages being consumed to encourage healthy eating habits.

Accordingly, the systems and arrangements described herein may aid in encouraging behaviors that may have a positive impact on a user and/or a user's lifestyle.

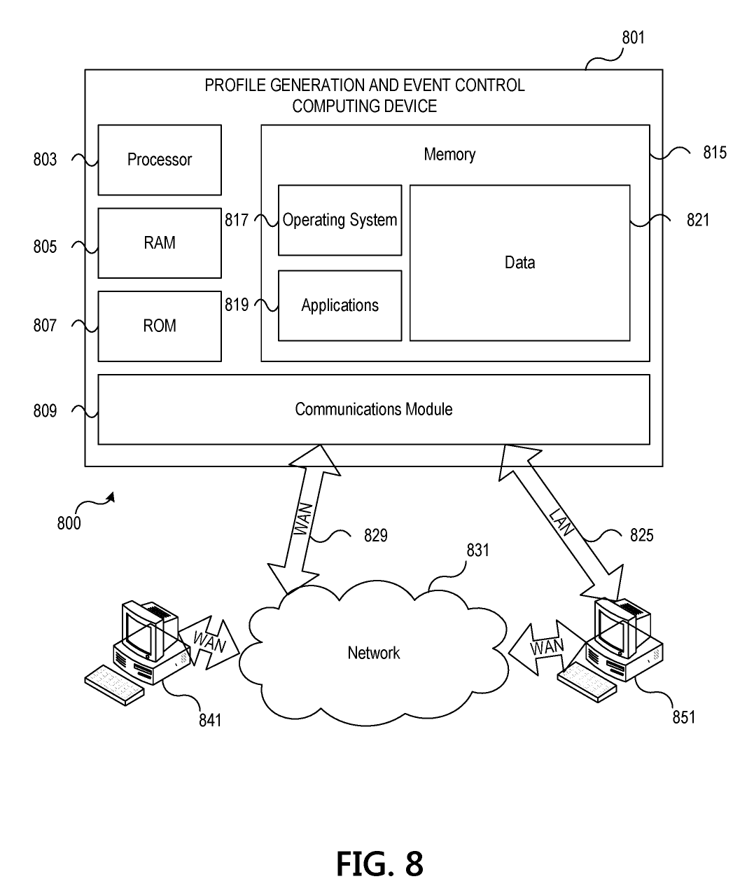

FIG. 8 depicts an illustrative operating environment in which various aspects of the present disclosure may be implemented in accordance with one or more example embodiments. Referring to FIG. 8, computing system environment 800 may be used according to one or more illustrative embodiments. Computing system environment 800 is only one example of a suitable computing environment and is not intended to suggest any limitation as to the scope of use or functionality contained in the disclosure. Computing system environment 800 should not be interpreted as having any dependency or requirement relating to any one or combination of components shown in illustrative computing system environment 800.

Computing system environment 800 may include profile generation and event control computing device 801 having processor 803 for controlling overall operation of profile generation and event control computing device 801 and its associated components, including Random Access Memory (RAM) 805, Read-Only Memory (ROM) 807, communications module 809, and memory 815. Profile generation and event control computing device 801 may include a variety of computer readable media. Computer readable media may be any available media that may be accessed by profile generation and event control computing device 801, may be non-transitory, and may include volatile and nonvolatile, removable and non-removable media implemented in any method or technology for storage of information such as computer-readable instructions, object code, data structures, program modules, or other data. Examples of computer readable media may include Random Access Memory (RAM), Read Only Memory (ROM), Electronically Erasable Programmable Read-Only Memory (EEPROM), flash memory or other memory technology, Compact Disk Read-Only Memory (CD-ROM), Digital Versatile Disk (DVD) or other optical disk storage, magnetic cassettes, magnetic tape, magnetic disk storage or other magnetic storage devices, or any other medium that can be used to store the desired information and that can be accessed by computing device 801.

Although not required, various aspects described herein may be embodied as a method, a data processing system, or as a computer-readable medium storing computer-executable instructions. For example, a computer-readable medium storing instructions to cause a processor to perform steps of a method in accordance with aspects of the disclosed embodiments is contemplated. For example, aspects of method steps disclosed herein may be executed on a processor on profile generation and event control computing device 801. Such a processor may execute computer-executable instructions stored on a computer-readable medium.

Software may be stored within memory 815 and/or storage to provide instructions to processor 803 for enabling profile generation and event control computing device 801 to perform various functions. For example, memory 815 may store software used by profile generation and event control computing device 801, such as operating system 817, application programs 819, and associated database 821. Also, some or all of the computer executable instructions for profile generation and event control computing device 801 may be embodied in hardware or firmware. Although not shown, RAM 805 may include one or more applications representing the application data stored in RAM 805 while profile generation and event control computing device 801 is on and corresponding software applications (e.g., software tasks) are running on profile generation and event control computing device 801.

Communications module 809 may include a microphone, keypad, touch screen, and/or stylus through which a user of profile generation and event control computing device 801 may provide input, and may also include one or more of a speaker for providing audio output and a video display device for providing textual, audiovisual and/or graphical output. Computing system environment 800 may also include optical scanners (not shown). Exemplary usages include scanning and converting paper documents, e.g., correspondence, receipts, and the like, to digital files.

Profile generation and event control computing device 801 may operate in a networked environment supporting connections to one or more remote computing devices, such as computing devices 841 and 851. Computing devices 841 and 851 may be personal computing devices or servers that include any or all of the elements described above relative to profile generation and event control computing device 801.

The network connections depicted in FIG. 8 may include Local Area Network (LAN) 825 and Wide Area Network (WAN) 829, as well as other networks. When used in a LAN networking environment, profile generation and event control computing device 801 may be connected to LAN 825 through a network interface or adapter in communications module 809. When used in a WAN networking environment, profile generation and event control computing device 801 may include a modem in communications module 809 or other means for establishing communications over WAN 829, such as network 831 (e.g., public network, private network, Internet, intranet, and the like). The network connections shown are illustrative and other means of establishing a communications link between the computing devices may be used. Various well-known protocols such as Transmission Control Protocol/Internet Protocol (TCP/IP), Ethernet, File Transfer Protocol (FTP), Hypertext Transfer Protocol (HTTP) and the like may be used, and the system can be operated in a client-server configuration to permit a user to retrieve web pages from a web-based server. Any of various conventional web browsers can be used to display and manipulate data on web pages.

The disclosure is operational with numerous other computing system environments or configurations. Examples of computing systems, environments, and/or configurations that may be suitable for use with the disclosed embodiments include, but are not limited to, personal computers (PCs), server computers, hand-held or laptop devices, smart phones, multiprocessor systems, microprocessor-based systems, set top boxes, programmable consumer electronics, network PCs, minicomputers, mainframe computers, distributed computing environments that include any of the above systems or devices, and the like and are configured to perform the functions described herein.

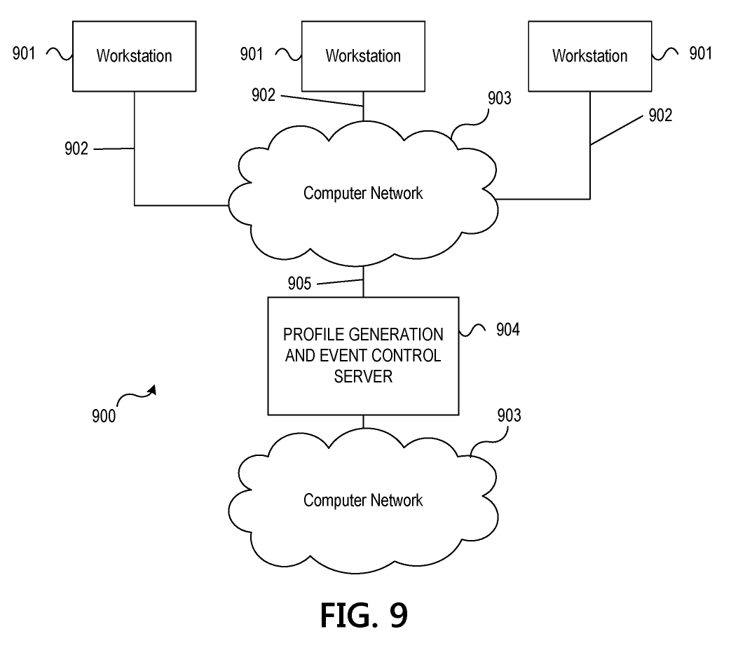

FIG. 9 depicts an illustrative block diagram of workstations and servers that may be used to implement the processes and functions of certain aspects of the present disclosure in accordance with one or more example embodiments. Referring to FIG. 9, illustrative system 900 may be used for implementing example embodiments according to the present disclosure. As illustrated, system 900 may include one or more workstation computers 901. Workstation 901 may be, for example, a desktop computer, a smartphone, a wireless device, a tablet computer, a laptop computer, and the like, configured to perform various processes described herein. Workstations 901 may be local or remote, and may be connected by one of communications links 902 to computer network 903 that is linked via communications link 905 to profile generation and event control server 904. In system 900, profile generation and event control server 904 may be a server, processor, computer, or data processing device, or combination of the same, configured to perform the functions and/or processes described herein. Server 904 may be used to process received data, generate profiles, implement profiles, execute controls, and the like.

Computer network 903 may be any suitable computer network including the Internet, an intranet, a Wide-Area Network (WAN), a Local-Area Network (LAN), a wireless network, a Digital Subscriber Line (DSL) network, a frame relay network, an Asynchronous Transfer Mode network, a Virtual Private Network (VPN), or any combination of any of the same. Communications links 902 and 905 may be communications links suitable for communicating between workstations 901 and profile generation and event control server 904, such as network links, dial-up links, wireless links, hard-wired links, as well as network types developed in the future, and the like.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, Application-Specific Integrated Circuits (ASICs), Field Programmable Gate Arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, one or more steps described with respect to one figure may be used in combination with one or more steps described with respect to another figure, and/or one or more depicted steps may be optional in accordance with aspects of the disclosure.

What is claimed is:

1. A profile generation and event control computing platform, comprising:
at least one processor;
a communication interface communicatively coupled to the at least one processor; and
memory storing computer-readable instructions that, when executed by the at least one processor, cause the profile generation and event control computing platform to:
generate a plurality of profiles based on one or more machine learning datasets;
identify a first profile of the plurality of profiles for a first user, the first profile including a first plurality of rules associated with the first profile;
associate the identified first profile with the first user, associating the identified first profile with the first user including identifying one or more controls, the one or more controls being based on the first plurality of rules associated with the first user profile;
receive a request to authorize an event by the first user;
determine, based on the first user profile of the first user, whether the event for which authorization is requested violates one or more rules of the first plurality of rules;
responsive to determining that the request for which authorization is requested violates one or more rules of the first plurality of rules, executing a first control of the one or more controls to deny authorization and prevent execution of the event; and
responsive to determining that the event for which authorization is requested does not violate one or more rules of the plurality of rules, executing a second control of the one or more controls to authorize and execute the event.

2. The profile generation and event control computing platform of claim 1, further including instructions that, when executed, cause the profile generation and event control computing platform to:
generate the plurality of machine learning datasets.

3. The profile generation and event control computing platform of claim 2, wherein generating the plurality of machine learning datasets includes:
receiving data from a plurality of sources, the data including data related to a plurality of users and a plurality of events;
analyzing the data over a period of time; and
linking event data to a level of success.

4. The profile generation and event control computing platform of claim 1, wherein determining, whether the event for which authorization is requested violates one or more rules of the first plurality of rules further includes:
transmitting a request to capture an image associated with an item associated with the event;
receiving the requested image; and
analyzing the image to determine whether the event for which authorization is requested violates the one or more rules of the first plurality of rules.

5. The profile generation and event control computing platform of claim 4, wherein the captured image includes a price of the item associated with the event.

6. The profile generation and event control computing platform of claim 4, wherein the captured image is received from a mobile device of the first user.

7. The profile generation and event control computing platform of claim 1, wherein executing the first control of the one or more controls includes disabling functionality of a mobile payment system on a mobile device of the first user.

8. The profile generation and event control computing platform of claim 1, wherein executing the second control of the one or more controls includes processing the event.

9. The profile generation and event control computing platform of claim 1, wherein the plurality of profiles each include a framework outlining a percentage associated with a plurality of categories.

10. A method, comprising:
at a computing platform comprising at least one processor, memory, and a communication interface:
generating, by the at least one processor, a plurality of profiles based on one or more machine learning datasets;
identifying, by the at least one processor a first profile of the plurality of profiles for a first user, the first profile including a first plurality of rules associated with the first profile;
associating, by the at least one processor, the identified first profile with the first user, associating the identified first profile with the first user including identifying one or more controls, the one or more controls being based on the first plurality of rules associated with the first user profile;
receiving, by the at least one processor and via the communication interface, a request to authorize an event by the first user;
determining, by the at least one processor and based on the first user profile of the first user, whether the event for which authorization is requested violates one or more rules of the first plurality of rules; and
responsive to determining whether the event for which authorization is requested violates one or more rules of the first plurality of rules, executing one of a first control and a second control.

11. The method of claim 10, further including:
responsive to determining that the request for which authorization is requested violates one or more rules of the first plurality of rules, executing the first control of the one or more controls to deny authorization and prevent execution of the event.

12. The method of claim 10, further including:
responsive to determining that the event for which authorization is requested does not violate one or more rules of the plurality of rules, executing the second control of the one or more controls to authorize and execute the event.

13. The method of claim 10, further including:
generating, by the at least one processor, the plurality of machine learning datasets.

14. The method of claim 13, wherein generating the plurality of machine learning datasets includes:
receiving data from a plurality of sources, the data including data related to a plurality of users and a plurality of events;
analyzing the data over a period of time; and
linking event data to a level of success.

15. The method of claim 10, wherein determining, whether the event for which authorization is requested violates one or more rules of the first plurality of rules further includes:
transmitting, by the at least one processor and via the communication interface, a request to capture an image associated with an item associated with the event;
receiving, by the at least one processor and via the communication interface, the requested image; and
analyzing, by the at least one processor, the image to determine whether the event for which authorization is requested violates the one or more rules of the first plurality of rules.

16. The method of claim 15, wherein the captured image includes a price of the item associated with the event.

17. The method of claim 10, wherein executing the first control of the one or more controls includes disabling functionality of a mobile payment system on a mobile device of the first user.

18. One or more non-transitory computer-readable media storing instructions that, when executed by a computing platform comprising at least one processor, memory, and a communication interface, cause the computing platform to:
generate a plurality of profiles based on one or more machine learning datasets;
identify a first profile of the plurality of profiles for a first user, the first profile including a first plurality of rules associated with the first profile;
associate the identified first profile with the first user, associating the identified first profile with the first user including identifying one or more controls, the one or more controls being based on the first plurality of rules associated with the first user profile;
receive a request to authorize an event by the first user;
determine, based on the first user profile of the first user, whether the event for which authorization is requested violates one or more rules of the first plurality of rules;
responsive to determining that the request for which authorization is requested violates one or more rules of the first plurality of rules, executing a first control of the one or more controls to deny authorization and prevent execution of the event; and
responsive to determining that the event for which authorization is requested does not violate one or more rules of the plurality of rules, executing a second control of the one or more controls to authorize and execute the event.

19. The one or more non-transitory computer-readable media of claim 18, further including instructions that, when executed, cause the computing platform to:
generate the plurality of machine learning datasets.

20. The one or more non-transitory computer-readable media of claim 19, wherein generating the plurality of machine learning datasets includes:
receiving data from a plurality of sources, the data including data related to a plurality of users and a plurality of events;
analyzing the data over a period of time; and
linking event data to a level of success.

21. The one or more non-transitory computer-readable media of claim 18, wherein determining, whether the event for which authorization is requested violates one or more rules of the first plurality of rules further includes:
transmitting a request to capture an image associated with an item associated with the event;
receiving the requested image; and
analyzing the image to determine whether the event for which authorization is requested violates the one or more rules of the first plurality of rules.

22. The one or more non-transitory computer-readable media of claim 21, wherein the captured image includes a price of the item associated with the event.

23. The one or more non-transitory computer-readable media of claim 18, wherein executing the first control of the one or more controls includes disabling functionality of a mobile payment system on a mobile device of the first user.
